(19) United States
(12) Patent Application Publication
(10) Pub. No.: US 2014/0087902 A1
(43) Pub. Date: Mar. 27, 2014

(54) TENSIONING DEVICE FOR A TRACTION-DEVICE DRIVE

(71) Applicant: Schaeffler Technologies AG & Co. KG, Herzogenaurach (DE)

(72) Inventors: Gilson Arima, Sorocaba (BG); Marcos Bernard Pinto, Sao Paulo (BR); Breno Carneiro, Sorocaba -S.P. (BR); Mario Junghahnel, Sao Paulo (BR)

(21) Appl. No.: 14/033,936

(22) Filed: Sep. 23, 2013

(30) Foreign Application Priority Data
Sep. 24, 2012 (DE) DE102012217206.8

(51) Int. Cl. F16H 7/08

(52) U.S. Cl. CPC F16H 7/0829
USPC 474/110

(57) ABSTRACT

A tensioning device (08) for a traction-device drive having a dynamically operable tensioning element (04) which acts on a traction device (03). It is a feature of the tensioning device that it has an electromagnetic actuator (09) for operating the tensioning element (04) as a function of deflections of the traction device (03) transverse to the longitudinal extent of the traction device (03).

This claims the benefit of German Patent Application DE 10 2012 217 206.8, filed Sep. 24, 2012 and hereby incorporated by reference herein.

The present invention relates to a tensioning device for a traction-device drive having a dynamically operable tensioning element which acts on a traction device.

### BACKGROUND

Traction-device drives are used, inter alia, to transmit rotational movements in internal combustion engines. For example, the rotation of a crankshaft can be transmitted to camshafts by a traction device. The traction device used in traction-device drives include straps, belts, V-belts, toothed belts, or chains. Transmission of force takes place over a large speed range, for example, up to the maximum speed of the internal combustion engine. In order to maintain the traction device under sufficient pretension so as to keep it from coming off a driving wheel and to prevent tooth jumping and excessive slippage, it is known to use a tensioning device which has a tensioning element and acts on the traction device. The tensioning element may, for example, take the form of a tensioning blade which is pivotally mounted about a pivot axle and which either is acted upon by a spring force or capable of being hydraulically pressed against the moving traction device. The tensioning devices used in traction-device drives must be able to protect the traction-device drive at all speeds occurring during operation thereof. Depending on the speed and the characteristics of the driving and driven assemblies, the traction devices may have resonant vibration ranges which require different adjustments and/or damping properties of the tensioning device. This means for the particular vibration ranges that a higher or a lower force is exerted by the tensioning device on the moving traction device, and that the force applied differs from that applied in operating ranges outside of vibrational resonance. While tensioning devices can be optimally adjusted to such a resonance zone, often only a compromise solution is obtained for ranges outside the resonance zone with respect to the adjustment of the tensioning device.

International Patent Document WO 2007/033879 A1 discloses a traction-device drive for an internal combustion engine having a traction device which takes the form of a belt or chain and is trained over the driving and driven wheels of a crankshaft and a camshaft. The traction-device drive is is provided with at least one tensioning element which guides the traction device and is movable in an oscillating manner by a controllable actuating means so as to couple vibrations into the traction-device drive. The tensioning element may be in the form of a tensioning blade pivotally mounted about a pivot point. The coupling-in of the actively generated vibrations is performed in such a way that they cancel out the unwanted vibrations occurring during operation.

International Patent Document WO 2008/119614 A1 describes a tensioning device for a traction-device drive having a dynamically operable tensioning element which acts on a traction device. In order to reduce resonant vibrations of the traction device over the entire speed range, a piezoelectric element is associated with the tensioning device in such a way that a vibration of the traction device occurring transversely to the longitudinal extent of the traction device can be used by the piezoelectric element to generate an electric current. This electric current serves as a controlled variable and can be supplied to a control device for changing the damping of the tensioning device.

### SUMMARY OF THE INVENTION

It is an object of the present invention to provide an improved tensioning device for a traction-device drive, which will make it possible to actively reduce resonant vibrations of the traction device in an optimal way over the entire operating speed range thereof. It is part of this objective to design the tensioning device in such a way that it accounts for the basic goal of optimized energy utilization.

The tensioning device according to the present invention includes an electromagnetic actuator for operating the tensioning element as a function of deflections of the traction means transverse to the longitudinal extent of the traction means.

A significant advantage of the approach of the present invention is that the tensioning elements can be controlled as a function of instantaneous vibrations of the traction device. This makes it possible to reduce unwanted vibrations of the traction means and resulting undesired effects promptly upon occurrence thereof. Unwanted belt oscillations can be damped in an optimal way over substantially the entire speed range.

In a preferred embodiment, the tensioning device of the present invention has a displacement sensor for measuring the deflection of the traction device transverse to the longitudinal extent of the traction device. The displacement sensor used may be, for example, a differential transformer. However, it is also possible to use other suitable displacement sensors.

Furthermore, the tensioning device of the present invention is preferably equipped with a control unit for controlling the electromagnetic actuator. The control unit processes the measurements or data provided by the displacement sensor so as to control the electromagnetic actuator as a function of the instantaneous deflection of the traction device.

It has proved advantageous to provide the tensioning device of the present invention with a pre-tensioning element for applying a pre-tensioning force to the traction device in a direction transverse to the longitudinal extent of the traction means. The pre-tensioning force may be provided mechanically using a spring element. Alternatively, the pre-tensioning force may also be a magnetic force generated by a magnetic circuit.

It is also advantageous to integrate an energy storage device into the tensioning device of the present invention in order to store the voltage induced in the magnetic circuit of the electromagnetic actuator due to the deflections of the traction device. Unlike the prior art, such excess vibrational energy does not have to be converted to heat or taken up by frame units. The energy stored in the energy storage device is preferably used to power the electromagnetic actuator and/or the pre-tensioning element that takes the form of a magnetic circuit. Thus, no separate power supply is needed to power the actuator and/or the magnetic circuit, or at least the energy consumption is reduced. The energy balance of the overall system can be improved by recycling the released energy. At the same time, the use of the energy provided by the traction device in accordance with the present invention reduces the mechanical and thermal stresses on the bearing systems. This increases the service life of the bearing systems and may allow them to be manufactured using less material.

### BRIEF DESCRIPTION OF THE DRAWINGS

Other advantages, features and embodiments of the present invention will become apparent from the following description of preferred embodiments of the tensioning device of the invention, given with reference to the accompanying drawings, in which:

FIG. 1 is a simplified side view showing a traction-device drive having a tensioning device according to the present invention;

FIG. 2 is a schematic diagram showing a first embodiment of the tensioning device according to the present invention;

FIG. 3 is a schematic diagram showing a second embodiment of the tensioning device according to the present invention.

### DETAILED DESCRIPTION

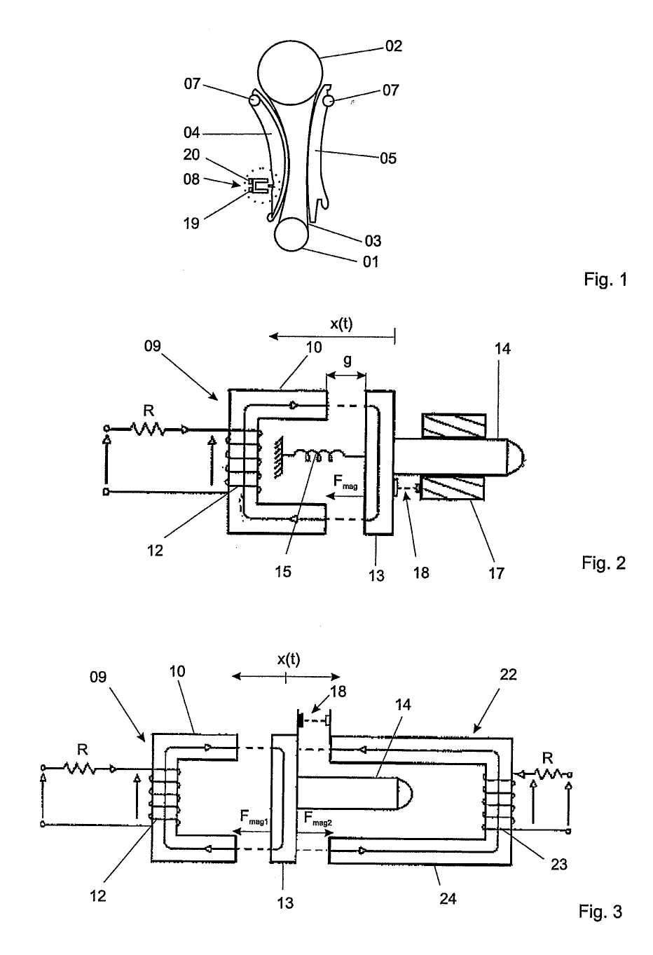

FIG. 1 shows a traction-device drive having a tensioning device according to the present invention. The traction-device drive includes a driving wheel 01 mounted on a crankshaft and a driven wheel 02 mounted on a camshaft. Of course, it is also possible to use a plurality of driven wheels 02 mounted on additional camshafts. In addition, it is possible to incorporate additional assemblies into the traction-device drive. Driving wheel 01 and driven wheel 02 are wrapped by a traction device 03. Traction device 03 may be, for example, a belt or a chain. Rotation of the crankshaft, and the associated rotation of driving wheel 01, will accordingly rotate driven wheel 02 and thus the camshaft, which are coupled by traction device 03. A tensioning element in the form of a tensioning blade 04 and a guide blade 05, which are pivotally mounted about a respective pivot axle 07, serve to guide traction device 03 and maintain it under sufficient tension.

A tensioning device 08, shown in detail in FIGS. 2 and 3, is disposed at tensioning blade 04. Tensioning device 08 enables tensioning blade 04 to be pressed more or less against traction device 03 in order to maintain traction device 03 under sufficient, but not excessive tension.

FIG. 2 shows a first embodiment of the tensioning device according to the present invention. The inventive tensioning device 08 includes an electromagnetic actuator 09 including a first electromagnet 10 having a first coil 12 for generating a magnetic flux, and further including a displaceable armature 13. Armature 13 is connected to a pusher 14. When first electromagnet 10 is energized, pusher 14 is movable against the force of a pre-tensioning element 15. In the embodiment shown, the pre-tensioning element takes the form of a spring element 15. The end of pusher 14 is in contact with tensioning blade 04 to cause the desired tensioning force to act on the traction device 03. The force provided by energizing first electromagnet 10 acts via displaceable armature 13 and the pusher 14 connected thereto in a direction transverse to the longitudinal extent of the traction device 03 to be tensioned. The force introduced by pusher 14 is approximately normal to the running surface of traction device 03 in the region of tensioning blade 04. Pusher 14 is preferably guided in a guide sleeve 17.

The tensioning device 08 of the present invention further includes a displacement sensor 18 for measuring the deflection of traction device 03. The displacement sensor 18 used may be, for example, a differential transformer. The values measured by displacement sensor 18 are transmitted to and processed by a control unit 19 (see FIG. 1).

The deflections of traction device 03 occurring during operation result in a displacement of pusher 14, which is in contact with traction device 03, and thus also of armature 13. The movement of the armature causes a change in the magnetic flux in the magnetic circuit, thereby inducing a voltage in coil 12. The induced voltage can be stored in an energy storage device 20 (see FIG. 1). The energy storage device 20 used may be, for example, a capacitor. Energy storage device 20 is mainly used to power electromagnetic actuator 09. This eliminates the need for a separate power supply source, or at least reduces the demands placed on it. Excess energy may optionally also be fed to a central storage battery to be available for other purposes.

The position of pusher 14 and the associated orientation of tensioning blade 04 can be controlled by changing the current flowing through coil 12. This results in different magnetic forces F_{mag}, which are directed opposite to the force of pre-tensioning element 15 and able to move pusher 14, and thus tensioning blade 04, to different positions x. It is particularly advantageous in this connection that it is possible to implement a dynamically operating tensioning device. The force applied by tensioning element 04 can be rapidly adjusted to changing load conditions in response to vibrations occurring in the traction device 03. In this way, vibrations are optimally damped, making it possible to substantially prevent resonance conditions. This allows for a significant reduction of the mechanical stresses placed on the traction device and on the bearings in the traction-device drive.

To be able to implement such control, displacement sensor 18 measures the current position of pusher 14 and communicates it to control unit 19. Control unit 19 compares the current position of pusher 14 to predefined reference values and determines therefrom the magnetic force F_{mag} required to position pusher 14 accordingly. The magnetic force F_{mag} acting in the actuator may be determined in accordance with the following equation:

F_{mag}=(u₀*N²*I²*Ag)/(4*g²)

where
u₀: permeability to air
N: number of coil windings
I: current intensity
Ag: area of air gap
g: width of air gap

Electromagnetic actuator 09 may also be implemented using two electromagnets 10 with the same poles or a combination of winding sets to generate the corresponding magnetic forces.

A first calibration of the inventive tensioning device 08 to different loads, torques, displacements, and the like, may be performed by dynamic simulation. Alternatively, the calibration may also be performed on an engine test bench with the aid of measurements.

FIG. 3 shows a second embodiment of the tensioning device according to the present invention. This embodiment differs from that shown in FIG. 2 in that the pre-tensioning element is implemented using a magnetic circuit 22 instead of a spring element 15. Thus, two magnetic circuits are present in this embodiment. The first magnetic circuit includes first electromagnet 10 with first coil 12, and armature 13. The side of armature 13 facing away from the end of pusher 14 that acts on tensioning blade 04 faces the first electromagnet 10. Second magnetic circuit 22 is formed by a second electromagnet 23 having a second coil 24 for generating a magnetic flux, and armature 13. The side of armature 13 facing the end of pusher 14 that acts on tensioning blade 04 faces the second electromagnet 23. Pusher 14 may extend at least partially between the legs of the second electromagnet. The leg ends of second electromagnet 23 are preferably oriented parallel to pusher 14. The region of the leg ends oriented parallel to pusher 14 preferably merges into an angled yoke region in order not to obstruct the movement of the pusher or prevent it from being coupled to tensioning blade 04.

When second electromagnet 23 is energized, a second magnetic force F_{mag2} is generated which is directed toward the end of pusher 14 that acts on tensioning blade 04 and which, consequently, is opposed to the first magnetic force F_{mag1} generated in the first magnetic circuit. Second magnetic force F_{mag2} performs the same function as the force generated by the spring element in FIG. 2. One advantage of the embodiment shown in FIG. 3 is that in this implementation variant, the pre-tensioning force can also be varied. There is no more need for a mechanical spring element to generate the pre-tensioning force. In this way, it is possible to enhance the response time of the overall system.

### LIST OF REFERENCE NUMERALS

01 driving wheel

02 driven wheel

03 traction device

04 tensioning blade

05 guide blade

07 pivot axle

08 tensioning device

09 electromagnetic actuator

10 first electromagnet

12 first coil

13 armature

14 pusher

15 spring element

17 guide sleeve

18 displacement sensor

19 control unit

20 energy storage device

22 magnetic circuit

23 second electromagnet

24 second coil

What is claimed is:

1. A tensioning device for a traction-device drive comprising:
a dynamically operable tensioning element acting on a traction device; and
an electromagnetic actuator for operating the tensioning element as a function of deflections of the traction device transverse to a longitudinal extent of the traction device.

2. The tensioning device as recited in claim 1 further comprising a displacement sensor for measuring the deflection of the traction device transverse to the longitudinal extent of the traction device.

3. The tensioning device as recited in claim 2 wherein the displacement sensor is a differential transformer.

4. The tensioning device as recited in claim 1 further comprising a control unit for controlling the electromagnetic actuator.

5. The tensioning device as recited in claim 1 further comprising a pre-tensioning element for applying a pre-tensioning force to the traction device in a direction transverse to the longitudinal extent of the traction device.

6. The tensioning device as recited in claim 5 wherein the pre-tensioning element is a spring element.

7. The tensioning device as recited in claim 5 wherein the pre-tensioning element is a magnetic circuit.

8. The tensioning device as recited in claim 1 further comprising an energy storage device for storing the voltage induced in the magnetic circuit of the electromagnetic actuator due to the deflections of the traction device.

9. The tensioning device as recited in claim 8 wherein the energy storage device is used to power the electromagnetic actuator and/or the pre-tensioning element that takes the form of a magnetic circuit.

10. The tensioning device as recited in claim 8 wherein the energy storage device is provided by a capacitor or an electrochemical storage battery.
